(19) United States
(12) Patent Application Publication
(10) Pub. No.: US 2020/0411829 A1
(43) Pub. Date: Dec. 31, 2020

(54) Battery, and Battery Diaphragm and Manufacturing Method Therefor

(71) Applicants: Shenzhen Senior Technology Material Co., Ltd., Shenzhen, Guangdong (CN); Jiangsu Senior New Material Technology Co., Ltd, Changzhou, Jiangsu (CN)

(72) Inventors: Yanjie WANG, Shenzhen (CN); Xuemei YANG, Shenzhen (CN); Bin TAN, Shenzhen (CN); Zhijie WU, Shenzhen (CN)

(73) Assignees: Shenzhen Senior Technology Material Co., Ltd., Shenzhen, Guangdong (CN); Jiangsu Senior New Material Technology Co., Ltd, Changzhou, Jiangsu (CN)

(21) Appl. No.: 16/975,206

(22) PCT Filed: May 6, 2019
(86) PCT No.: PCT/CN2019/085704

§ 371 Date: Aug. 24, 2020

(30) Foreign Application Priority Data
May 16, 2018 (CN) 201810471842.3

(51) Int. Cl. H01M 2/16; H01M 2/14; H01M 10/0525

(52) U.S. Cl. CPC H01M 2/1686; H01M 2/1653; H01M 10/0525; H01M 2/145; H01M 2/1646

(57) ABSTRACT

Disclosed are a battery, and a battery diaphragm and a manufacturing method therefor, which belong to the field of batteries. The battery diaphragm has a composite structure constituted by a first member and a second member. The diaphragm includes: the first element is manufactured from a modification material provided to improve the thermal stability of the diaphragm, the first element being a stack of nanowires distributed in layers; and the second element is manufactured from a base material provided to serve as the body of the diaphragm, the first element being loaded on the second element and supported by the second element.

### CROSS-REFERENCE TO RELATED APPLICATIONS

This application claims priority to Chinese Patent Application No. 2018104718423, filed with the Chinese Patent Office on May 16, 2018, entitled “Battery, And Battery Diaphragm and Manufacturing Method Therefor”, which is incorporated herein by reference in its entirety.

### TECHNICAL FIELD

The present disclosure relates to the field of batteries, and in particular to a battery, a battery separator (or diaphragm), and a method for manufacturing the same.

### BACKGROUND ART

The lithium ion battery is a secondary battery currently widely applied. The lithium ion battery operates mainly by movement of lithium ions between positive and negative electrodes. Li⁺ is reversibly intercalated into and deintercalated from the two electrodes during charging and discharging processes. During the charging, Li⁺ is deintercalated from the positive electrode and intercalated into the negative electrode through an electrolyte so that the negative electrode is in a lithium-rich state. Moreover, higher charging capacity is obtained when more lithium ions are intercalated into the negative electrode. During the discharging, on the contrary, the lithium ions intercalated into a carbon layer of the negative electrode are deintercalated therefrom and then move back to the positive electrode through the electrolyte. Higher discharging capacity is obtained when more lithium ions move back to the positive electrode.

The lithium ion batteries have the advantages such as high operating voltage of unit cells, high specific energy, long cycle life, low self-discharge, no pollution, and no memory effect. Therefore, they are widely applied to mobile phones, portable devices, automobiles, aviation, scientific research, entertainment, military, and other modern electronic fields and are gradually replacing conventional batteries.

A lithium ion battery is mainly composed of four major materials, including a positive electrode material, a negative electrode material, a separator, and an electrolyte. As one of its important constituent parts, the separator plays a very important role in terms of the battery's performance. The battery separator refers to a layer of diaphragm material between the positive and negative electrodes of the battery, and is usually called a battery separator. The main function of the battery separator is to isolate the positive and negative electrodes from each other and to prevent electrons in the battery from freely passing therethrough, while allowing ions in the electrolyte to pass freely between the positive and negative electrodes.

The ion conductivity of the battery separator is directly related to the overall performance of the battery. Its function of isolating the positive and negative electrodes from each other allows for a limited increase in current in case of overcharging or temperature increment of the battery, thereby preventing explosion of the battery caused by short circuit of the battery. The battery separator has a protective function due to its self-closable micropores to safely protect a user and a device using the battery. Polyolefin materials are widely used for making a microporous separator because of their advantages such as low price, good mechanical strength and chemical stability, good overall performance, and low cost. However, their further applications to batteries are restricted due to their shortcomings in thermal stability.

The information disclosed in the Background Art section is only intended to facilitate understanding of the overall background art of the present disclosure, and shall not be deemed as admitting or implying in any form that the information constitutes the prior art well known to those skilled in the art.

### SUMMARY

The present disclosure provides a battery separator.

The battery separator has a composite structure including a first element and a second element.

The separator includes:

the first element made of a modification material provided to improve thermal stability of the battery separator, wherein the first element is a stack of nanowires distributed in one or more layers; and

the second element made of a base material provided as a main body of the battery separator, wherein the first element is loaded on the second element and supported by the second element.

In one or more examples, the first element has a thickness of the order of microns and/or sub-microns or less.

In one or more examples, the first element has a thickness of 0.01 to 1 μm.

In one or more examples, the nanowire has a length-to-diameter ratio of greater than 50.

In one or more examples, the nanowire has a diameter of 1 to 100 nm and a length of 0.1 to 100 μm.

In one or more examples, the modification material includes one or more of carbon nanotubes, silver nanowires, boron carbide nanowires, nanocellulose, copper hydroxide nanowires, silicon monoxide nanowires, and hydroxyapatite nanowires.

In one or more examples, the base material is an organic polymer material.

In one or more examples, the organic polymer material includes polyolefin.

In one or more examples, the polyolefin includes polyethylene.

In one or more examples, the first element is in a porous structure.

The present disclosure further provides a method for manufacturing a battery separator described above.

The method for manufacturing a battery separator is used for manufacturing a battery separator having a structure described below.

The battery separator includes a first element and a second element, wherein the first element is loaded on the second element in a layered manner, and the first element is constituted by nanowires.

The manufacturing method includes steps of:

providing a dispersion solution in which the nanowires are dispersed in a dispersant; and

transferring the dispersion solution to a surface of the second element, and removing the dispersant in the dispersion solution from the surface of the second element so that the nanowires are loaded on the surface of the second element in the layered manner.

In one or more examples, the dispersant includes one or more of water, ethanol, acetone, and N-methylpyrrolidone, and the dispersion solution further contains an adhesive.

In one or more examples, the adhesive includes one or more of polyvinyl alcohol, polyacrylonitrile, polyacrylic acid, styrene butadiene rubber, carboxymethyl cellulose, polyvinylidene fluoride, polyvinylpyrrolidone, and polyimide.

In one or more examples, the dispersion solution further includes an auxiliary agent.

In one or more examples, the dispersion solution includes 0.01 to 50% by mass concentration of the nanowires, and 0.01 to 49% by mass concentration of the adhesive.

In one or more examples, the dispersion solution is transferred to the surface of the second element by means of coating.

In one or more examples, the coating includes spin coating, or blade coating, or dip coating.

In one or more examples, the dispersed solution is transferred to the surface of the second element by dip coating, and the dip coating method includes:

dipping the second element into the dispersion solution at a first given speed and withdrawing the second element from the dispersion solution at a second given speed under a condition where the second element is tensioned by being stretched.

In one or more examples, the second element is tensioned by a tensioning system consisting of a plurality of rollers, wherein the tensioning system has at least one dip coating roller configured to dip the second element into the dispersion solution, and the dip coating roller is partially or entirely immersed in the dispersion solution.

In one or more examples, the dip coating roller has a hollow cavity, and the dip coating roller has pore channels communicating with the hollow cavity and extending to its surface, the second element is in contact with the surface of the dip coating roller in such a manner that the surface of the dip coating roller and the surface of the second element are attached to each other, and the hollow cavity is held at a given vacuum degree.

In one or more examples, the vacuum degree is 0.01 to 0.1 MPa.

The present disclosure further discloses a battery, having the battery separator as described above.

### Advantageous Effects

The battery separator according to the present disclosure has a composite structure, which is an innovation over the prior art battery separators and is improved in terms of thermal stability by using a modification material. Further, the modification material is used in the form of nanowires. This can avoid the problem of an increase in thickness and weight of the separator caused by the introduction of the modification material, thereby achieving effects of thermal stability and less increment of thickness and weight of the battery separator.

### BRIEF DESCRIPTION OF DRAWINGS

In order to more clearly illustrate technical solutions of embodiments of the present disclosure, drawings required for use in the embodiments will be described briefly below. It is to be understood that the drawings below are merely illustrative of some embodiments of the present disclosure, and therefore should not be considered as limitations on its scope. It will be understood by those of ordinary skill in the art that other relevant drawings can also be obtained from these drawings without any inventive effort.

FIG. 1 is a schematic structural view of a first battery separator according to an embodiment of the present disclosure;

FIG. 2 is a schematic structural view of a second battery separator according to an embodiment of the present disclosure;

FIG. 3 is a schematic structural view of a film formation apparatus for making the second battery separator according to an embodiment of the present disclosure;

FIG. 4 shows a schematic structural view, from a first perspective, of a dip coating roller of the film formation apparatus of FIG. 3;

FIG. 5 shows a schematic structural view, from a second perspective, of the dip coating roller of the film formation apparatus of FIG. 3; and

FIG. 6 is a schematic sectional structural view of the dip coating roller of the film formation apparatus of FIG. 3 taken along an axial direction.

Reference Numerals: 100—first element; 200—second element; 300—porous structure; 401—storage tank; 402—tensioning system; 403—dip coating roller; 4031—hollow cavity; 4032—pore channel.

### DETAILED DESCRIPTION OF EMBODIMENTS

In order to further clarify the objects, technical solutions, and advantages of the embodiments of the present disclosure, the technical solutions of the embodiments of the present disclosure will be described below clearly and completely with reference to the drawings of the embodiments of the present disclosure. It is apparent that the embodiments to be described are some, but not all of the embodiments of the present disclosure. Generally, the components of the embodiments of the present disclosure, as described and illustrated in the figures herein, may be arranged and designed in a wide variety of different configurations. Thus, the following detailed description of the embodiments of the present disclosure, as represented in the figures, is not intended to limit the scope of the present disclosure as claimed, but is merely representative of selected embodiments of the present disclosure. All other embodiments obtained by those of ordinary skill in the art in light of the embodiments of the present disclosure without inventive efforts shall fall within the scope of the present disclosure as claimed.

It should be noted that similar reference numerals and letters refer to similar items in the following figures, and thus once an item is defined in one figure, it may not be further defined or explained in the subsequent figures.

In the description of the present disclosure, it should be noted that orientation or positional relations indicated by the terms such as “center”, “up”, “down”, “left”, “right”, “vertical”, “horizontal”, “inside”, and “outside” are the orientation or positional relations shown based on the figures, or the orientation or positional relations in which the inventive product is conventionally placed in use, and these terms are intended only to facilitate the description of the present disclosure and simplify the description, but not intended to indicate or imply that the referred devices or elements must be in a particular orientation or constructed or operated in the particular orientation, and therefore should not be construed as limiting the present disclosure. In addition, terms such as “first”, “second”, and “third” are used for distinguishing the description only, and should not be understood as an indication or implication of their relative importance.

In the description of the present disclosure, it should also be noted that terms “disposed”, “mounted”, “coupled”, and “connected” should be understood broadly unless otherwise expressly specified or defined. For example, a connection may be fixed connection or detachable connection or integral connection, may be mechanical connection or electric connection, or may be direct coupling or indirect coupling via an intermediate medium or internal communication between two elements. The specific meanings of the above-mentioned terms in the present disclosure can be understood by those of ordinary skill in the art according to specific situations.

In the present disclosure, unless otherwise expressly specified or defined, a first feature “on” (or above) or “below” (or under) a second feature may include a case where the first and second features are in direct contact, and may also include a case where the first and second features are not in direct contact, but are in contact with each other via an additional feature therebetween. Moreover, a first feature “on”, “above”, or “over” a second feature is meant to include a case where the first feature is directly above or obliquely above the second feature, or merely means that the first feature is at a level height higher than the second feature. A first feature “below”, “under”, or “underneath” a second feature is meant to include a case where the first feature is directly below or obliquely below the second feature, or merely means that the first feature is at a level height lower than the second feature.

In the present disclosure, all the embodiments, implementations, and features of the present disclosure can be combined with one another without contradictions or conflicts. In the present disclosure, conventional devices, apparatuses, components, and the like may be either commercially available or self-manufactured according to the description disclosed in the present disclosure. In the present disclosure, some conventional operations and devices, apparatuses, and components are omitted or described briefly in order to highlight the gist of the present disclosure.

In the prior art, battery separators, especially polyolefin separators applied to lithium ion batteries (including primary batteries and secondary batteries), often have defects of poor thermal stability. It is often necessary to make an improvement on the basis of prior art separators in order to modify the separators to improve their thermal stability. In practice, the inventors have found that coating the surfaces of the prior art (battery) separators with inorganic materials such as aluminum oxide is a simple and efficient method that can improve the thermal stability of the separators.

However, the inventors have also found that the prior art coating method would cause adverse effects to some characteristics of an adjusted separator, for example, a significant increase in thickness and weight, which in turn leads to a decrease in the performance of the separator when in use.

In this embodiment, a material capable of improving the thermal stability of a separator is used in the form of nanowires and loaded on the original material of the separator, in order to achieve both desired thermal stability of the separator and no significant increase in thickness and weight of the separator.

In this embodiment, one-dimensional nanowires are used as the coating material (e.g., achieved by coating). The one-dimensional nanowires have much smaller sizes and densities than inorganic materials, and thus they can be controlled to a smaller thickness.

In addition, the one-dimensional nanowires have the potential to impart new characteristics to the separator or improve the existing characteristics of the separator due to their unique structural features and interface effects.

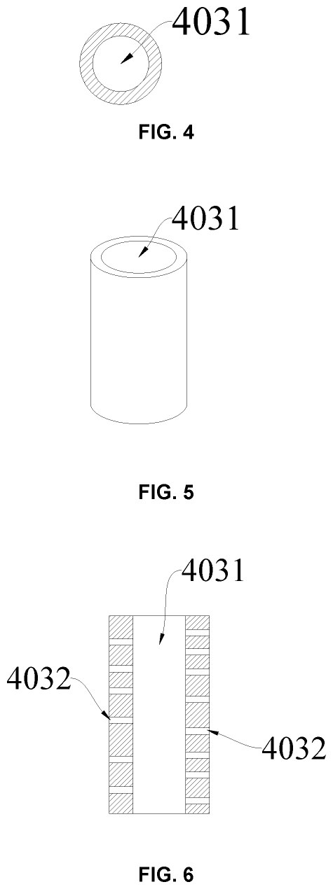

Reference can be made to FIGS. 1 to 6.

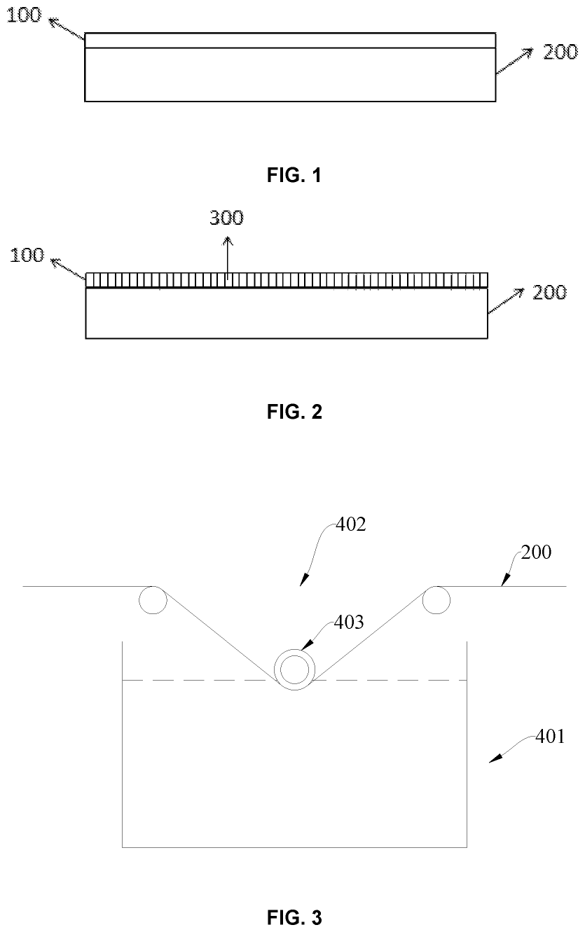

As shown in FIG. 1, this embodiment provides a battery separator which is a multi-layered composite combination. The battery separator has a composite structure including a first element 100 and a second element 200. Further, the above structure of the battery separator may be modified as required. For example, in FIG. 2, the battery separator has a composite structure including the first element 100 and the second element 200, and meanwhile the first element has a porous structure 300 having a plurality of pores.

In addition, it should be appreciated that FIGS. 1 and 2 merely schematically show the structure of the battery separator, but the absolute thickness of the first element, the absolute thickness of the second element, and the relative magnitude and ratio relations between the thicknesses of the two elements may not be determined according to the dimensions and scale illustrated in the figures. However, the thickness of the first element of the battery separator is significantly smaller than the thickness of the second element.

For example, in some examples, the first element has a thickness of the order of sub-microns or micrometers, and the second element may have a thickness of the order of millimeters or centimeters. In some more specific optional examples, the first element may have a thickness of 0.01 to 1 micrometer (μm), or the thickness of the first element is selected from any value of 0.03 μm, 0.05 μm, 0.08 μm, 0.1 μm, 0.4 μm, 0.6 μm, 0.8 μm, and 1 μm or any numerical value in a range determined between any two of the above values. Furthermore, the thickness of the first element may be standardized and verified according to specific product parameter requirements and test effects, and is not specifically limited in the embodiments of the present disclosure.

Further, in this embodiment, the first element is formed by nanowires. Therefore, based on difference in properties of the first element and the nanowires and the difficulty levels of the methods for manufacturing the same, in combination with the consideration of the performance of the battery separator, the size of the nanowires may be optionally defined as below. For example, the nanowire has a length-to-diameter ratio of greater than 50, for example, a length-to-diameter ratio of 146, 138, 127, or the like. Further, the length-to-diameter ratio of the nanowire may be adjusted by controlling a proper length and diameter of the nanowire. For example, the nanowire has a diameter of 1 to 100 nm and a length of 0.1 to 100 μm. In some specific optional examples, the nanowire has a diameter of 100 nm and a length of 5 μm.

The material of the battery separator may be selected from many choices and may be selected depending on specific practical situations.

Here, the first element is made of a modification material provided to improve the thermal stability of the separator, and the first element is a stack of nanowires distributed in one or more layers. Generally, in terms of macroscopic morphology, the first element is present in the form of a thin film (film layer, diaphragm) and has a thickness of the order of sub-microns or microns as described previously.

In addition, the aforementioned first element is a stack of nanowires, While the stack of nanowires may exist in various ways. For example, the first element may be a single-layer stacked structure having a thickness equal to a nanowire diameter, wherein the nanowires are arranged in an array. In the longitudinal direction, the nanowires in the same column are arranged in sequence in an end-to-end manner. In the transverse direction, multiple columns of nanowires are arranged side by side. Optionally, in some examples, the nanowires are stacked in a criss-crossed manner. Optionally, in some other examples, the nanowires are stacked in a randomly crossed manner. The stacking of the nanowires may be defined by the method for manufacturing the battery separator, which is not specifically limited in the embodiments of the present disclosure. Further, a stack composed of nanowires may have two layers, three layers, or even more layers, and each layer may be made by the same or a different method and stacked in the same or a different form.

The first element produced by a stack appropriately formed by nanowires has the characteristics of high porosity, uniform pore size, light weight, and high strength. Therefore, the nanowire coating has the characteristics of thin thickness and light weight while solving the problem of thermal stability of polyolefin separators, which is in conformity with the development direction of lightweight and high energy of batteries.

In addition, the aforementioned first element having pores may be formed by stacking nanowires on the second element. In other words, the poress may be formed without being produced artificially and actively in the process of manufacturing the battery separator, or the poress may also be considered to be purposefully controlled (distribution density, distribution mode, pore size) and formed. The formation of the poress, such as in terms of pore size, porosity, and so on, is controlled so as to adjust the effect of the battery separator having the first element and the second element on the movement of ions when the battery separator is used in a battery.

In light of the above, the modification material may be selected from many choices, for example, one or more of carbon nanotubes, silver nanowires, boron carbide nanowires, nanocellulose, copper hydroxide nanowires, silicon monoxide nanowires, and hydroxyapatite nanowires.

The second element is made of a base (or substrate) material provided as a main body of the separator, and the first element is loaded on the second element and supported by the second element. It should be noted that the aforementioned main body of the separator may be the separator itself in the prior art battery separator technology. In this embodiment, a separator for isolating electrons and allowing ions to pass therethrough is provided and used as a main body and exerts its corresponding effects on electrons and ions.

As described previously, there are many choices for the modification material for making the first element. Correspondingly, the base material for making the second element may also be selected from many choices and may be appropriately selected according to specific performance and process requirements.

In this embodiment, optionally, the second element is selected from polyolefins, such as polyethylene (PE), polypropylene (PP), etc.

Based on the above battery separator, an embodiment of the present disclosure further provides a battery, which may be a primary battery or a secondary battery, and may, for example, be a rechargeable lithium ion battery. The battery has a housing in which the above-mentioned battery separator and positive and negative electrodes separated by the battery separator are disposed. A positive electrode region is formed between the positive electrode and the battery separator, and a negative electrode region is formed between the negative electrode and the battery separator. The same electrolyte is injected into the positive electrode region and the negative electrode region.

In an embodiment of the present disclosure, corresponding to the above battery separator, a method for manufacturing a battery separator is further provided.

The manufacturing method includes following steps:

Step S101: providing a dispersion solution in which nanowires are dispersed in a dispersant.

Here, the nanowires are preferably fully dispersed in the dispersant, and the dispersant is generally a poor solvent for the nanowires in order to maintain the structure of the nanowires. Namely, the dispersant does not significantly dissolve the nanowires to destroy their nanostructures.

In addition, the nanowires are also preferably dispersed uniformly in the dispersant, rather than being aggregated in the dispersant. In some examples, the dispersion solution may be selected to be present and used in the form of a suspension liquid, a turbid liquid, or an emulsion.

In some embodiments of the present disclosure, as an example, water is selected and used as the dispersant, and carbon nanotubes are selected as the nanowires. The carbon nanotubes may be uniformly dispersed in water by vibration modes such as ultrasonic treatment and high speed stirring. Generally, the dispersion solution is easily prepared and used on site, which can avoid the problem of uneven distribution of nanowires in the dispersant. However, in some cases without high requirements or for dispersion solutions with good dispersion uniformity and stability, the dispersion solutions may be prepared in advance or outsourced and used. In addition, the nanowires may be contained in the dispersion solution at a concentration of 0.01 to 50 wt %, for example, 0.1 to 43 wt %, 3 to 36 wt %, 14 to 29 wt %, or the like.

The material of the nanowires may be selected as described previously, and therefore will not be described repeatedly here.

In some improved solutions, an adhesive may usually be added to the dispersant in order to improve the bonding strength between the first element and the second element. Moreover, the adhesive is usually compatible with the dispersant. Namely, a phenomenon affecting the uniform distribution of the nanowires, such as a significant delamination will not occur.

For example, in this embodiment, the dispersant may be selected from one or more of water, ethanol, acetone, and N-methylpyrrolidone. Accordingly, the adhesive may be selected from one or more of polyvinyl alcohol, polyacrylonitrile, polyacrylic acid, styrene butadiene rubber, carboxymethyl cellulose, polyvinylidene fluoride, polyvinylpyrrolidone, and polyimide. The adhesive may be contained at a concentration by mass of 0.01 to 49%, 5 to 37%, 11 to 27%, 16 to 20%, or the like.

Further, an auxiliary agent, including glycerin, sodium butylbenzenesulfonate, propylene glycol, and polyoxyethylene sulfide, may be added as a wetter to the dispersant.

Step S102: transferring the dispersion solution to a surface of the second element, and removing the dispersant in the dispersion solution from the surface of the second element so that the nanowires are loaded on the surface of the second element in a layered manner.

Here, the dispersion solution may be transferred by coating, such as spin coating or blade coating (scrape coating) or dip coating. The dispersant in the dispersion solution may be removed by evaporation. For example, the second element on which the dispersion solution is loaded is heated to evaporate the dispersant (e.g., water). The heating mode may be irradiation heating. In addition, the evaporation rate of the dispersion solution should be properly controlled so as to avoid affecting the strength of bonding of the formed first element on the second element due to an improper evaporation mode.

In an optional improved example of the present disclosure, the dispersion solution is transferred to the surface of the second element by dip coating.

For example, the dip coating method includes:

dipping the second element in the dispersion solution at a first given speed and withdrawing the second element from the dispersion solution at a second given speed under a condition where the second element is tensioned by being stretched. When the second element is passing through the dispersion solution, the nanowires in the dispersion solution and/or the optionally added adhesive are bonded to the second element by the actions such as chemical action, adsorption action, and capillary phenomenon; then, removing the dispersant in the dispersion solution from the surface of the second element in an appropriate manner while leaving the nanowires on the surface of the second element.

In particular, in this embodiment, the dispersion solution is transferred to the second element by a film formation apparatus. The general structure of the film formation apparatus may be depicted below with reference to FIG. 3.

The film formation apparatus includes a liquid storage tank 401 which is configured to store the dispersion solution.

The film formation apparatus further includes a tensioning system 402. The tensioning system includes a plurality of rollers. In FIG. 3, the tensioning system includes three rollers, wherein one of the rollers is distributed between the other two rollers, and a triangular shape may be formed by the center points of the projections of the three rollers on a plane. The second element of the battery separator is tensioned by the tensioning system. The tensioning system includes at least one dip coating roller 403 (i.e., the roller located in the middle as described above) configured to dip the second element 200 in the dispersion solution. The dip coating roller is partially or entirely immersed in the dispersion solution (by an immersed depth ranging from ¼ of its radius to its entirety in one example).

The immersed depth of the dip coating roller may be achieved by a moving mechanism (not shown in the figure), which enables the dip coating roller to move relative to the dispersion solution in an appropriate manner, for example, to move vertically. Also, the tensioning system may properly release the second element so as to adjust the immersed depth of the dip coating roller without moving the positions of the two rollers other than the dip coating roller. Optionally, in some examples, all of the three rollers constituting the tensioning system are movable, so that it is easier to control the adjustment of the immersed depth of the dip coating roller.

Optionally, the dip coating roller 403 has a hollow cavity 4031, and the dip coating roller has pore channels 4032 communicating with the hollow cavity and extending to its surface. The second element is in contact with the surface of the dip coating roller in such a manner that their surfaces are attached to each other, and the hollow cavity is held at a given vacuum degree. For example, the vacuum degree is 0.01 to 0.1 MPa. A vacuum generator configured to generate a desired vacuum degree in the dip coating roller is not shown in the figures, and may be selected from commercially available devices such as a vacuum pump.

In this way, when the second element is passing through the dispersion solution, the dispersion solution is more easily adsorbed by and bonded to the surface of the second element under the action of negative pressure. On the other hand, the porosity, pore size, and pore distribution of the first element can also be adjusted by controlling the pore channels of the dip coating roller to achieve the desired effect.

In addition, the thickness of the first element can be adjusted by adjusting the concentration of the nanowires in the dispersion solution, the immersed depth of the dip coating roller in the dispersion solution, and the vacuum degree of the dip coating roller. The inventors have found that a greater solution concentration results in a thicker coating, a deeper immersed depth results in a thicker coating, and a higher vacuum degree results in a thicker coating.

In addition, it should be noted that, in an embodiment of the present disclosure, the battery separator is a sheet structure having a multilayered film structure, wherein the second element constitutes a base film, and the first element constitutes a surface film. One or a plurality of layers of surface films may be provided. When a plurality of layers of surface films are provided, the surface films may be distributed on the two sides of the base film in the thickness direction and the same or a different number of layers of surface films may be distributed on each side, or the surface films may be distributed on either of the two sides of the base film in the thickness direction.

A number of examples of battery separators are listed in Table 1 below, including their raw materials, process methods, and properties.

TABLE 1
Manufacturing and Properties of Battery Separators

| | | | | | | | | | Thermal | |
|---|---|---|---|---|---|---|---|---|---|---|
| | | | | Roller | immersed | Vacuum | Dispersion | | Stability | |
| | Substrate | Nanowire | | Speed | Depth | Degree | Solution | Thickness | at 150° C. | |
| Group | Material | Material | Dispersant | (m/min) | (Diameter) | (Mpa) | Concentration | (μm) | for 1 h | |
| Ex. 1 | PE | Carbon | N-methyl | 30 | 1/4 | 0.05 | 10% | 0.1 | TD | 0.1% |
| | | Nanotubes | pyrrolidone | | Diameter | | | | MD | 0.1% |
| Ex. 2 | PP | Boron Carbide | Acetone | 20 | 1/4 | 0.1 | 0.1% | 0.01 | TD | 0.5% |
| | | Nanowires | | | Diameter | | | | MD | 0.5% |
| Ex. 3 | PE | Nanocellulose | Water | 50 | 1/2 | 0.1 | 50% | 0.2 | TD | 0.01% |
| | | | | | Diameter | | | | MD | 0.1% |
| Ex. 4 | PP | Hydroxyapatile | Ethanol | 10 | Fully | 0..1 | 80% | 0.8 | TD | 0.01% |
| | | Nanowires | | | Immersed | | | | MD | 0.1% |

Batteries are made by using the battery separators manufactured in the above Examples 1-4, and their electrical properties are tested. The test results are shown in Table 2 below.

TABLE 2
Properties of Batteries Using the Battery Separators

| | | Thermal Stability | Battery Capacity |
|---|---|---|---|
| Battery | Separator Coating | of the Separator at | Retention Rate |
| Separator Type | Thickness (μm) | 150° C. for 1 h | (%) |
| Example 1 | 0.1 | TD 0.1% | 99 |
| (PE) | | MD 0.1% | |
| Example 2 | 0.01 | TD 0.5% | 98.5 |
| (PP) | | MD 0.5% | |
| Example 3 | 0.2 | TD 0.01% | 99.2 |
| (PE) | | MD 0.1% | |
| Example 4 | 0.8 | TD 0.01% | 99.3 |
| (PP) | | MD 0.1% | |
| Comparative | 2 | TD 0.7% | 97 |
| Example 1 | | MD 1.1% | |
| (PE) | | | |
| Comparative | 2 | TD 1% | 97.2 |
| Example 2 | | MD 1.5% | |
| (PE) | | | |
| Comparative | 2 | TD 0.8% | 96.5 |
| Example 3 | | MD 1.2% | |
| (PP) | | | |
| Comparative | 2 | TD 0.9% | 96.8% |
| Example 4 | | MD 1.3% | |
| (PP) | | | |
| Comparative | 0 | TD 50% | 93.7% |
| Example 5 (PE) | | MD 40% | |
| Comparative | 0 | TD 90% | 94.1% |
| Example 6 (PP) | | MD 40% | |

In Table 2, the batteries in Examples 1-4 and Comparative Examples 1-6 have the same main structure, each including a positive electrode, a negative electrode, an electrolyte, and a separator.

The main differences between the batteries lie in that the separators of the batteries in Examples 1-4 are made by using the method proposed in the embodiment of the present disclosure and are loaded with nanowire coatings, whereas the separators of the batteries in Comparative Examples 1-4 are commercially available products and loaded with coatings of granular substances of the order of millimeters, and the separators of the batteries of Comparative Examples 5-6 are commercially available products and are not loaded with substances for forming coatings. The substrates of the battery separators in the respective examples and comparative examples, such as polyethylene films and polypropylene films, are all commercially available products. The polyethylene film and the polypropylene film may, for example, be made by a wet non-weaving process.

As can be seen from Tables 1 and 2 above, the battery separators according to the embodiments of the present disclosure are significantly improved in terms of thermal stability, and also the battery capacity retention rates of the batteries using the battery separators are improved to some extent. In Tables 1 and 2 above, TD represents the thermal stability (heat shrinkage rate) of the separator in the transverse direction, and MD represents the thermal stability (heat shrinkage rate) in the longitudinal direction.

The above description is merely illustrative of optional embodiments of the present disclosure and is not intended to limit the present disclosure. It will be understood by those skilled in the art that various modifications and variations can be made to the present disclosure. Any modifications, equivalent alternatives, improvements and so on made within the spirit and principle of the present disclosure are to be included in the scope of protection of the present disclosure.

### INDUSTRIAL APPLICABILITY

The battery separator according to the present disclosure has a composite structure, which is an innovation over the prior art battery separators and is improved in terms of thermal stability by using a modification material. Further, the modification material is used in the form of nanowires, which can avoid the problem of an increase in thickness and weight of the separator caused by the introduction of the modification material, thereby achieving the effects of thermal stability, and less increment of thickness and weight of the battery separator.

1. A battery separator having a composite structure comprising a first element and a second element, the battery separator comprising:
the first element, made of a modification material provided to improve thermal stability of the battery separator, wherein the first element is a stack of nanowires distributed in one or more layers; and
the second element made of a base material provided as a main body of the battery separator, wherein the first element is loaded on the second element and supported by the second element.

2. The battery separator according to claim 1, wherein the first element has a thickness of the order of microns and/or sub-microns or less.

3. The battery separator according to claim 1, wherein the first element has a thickness of 0.01 to 1 μm.

4. The battery separator according to claim 1, wherein the nanowire has a length-to-diameter ratio of greater than 50.

5. The battery separator according to claim 4, wherein the nanowire has a diameter of 1 to 100 nm and a length of 0.1 to 100 μm.

6. The battery separator according to claim 1, wherein the modification material comprises one or more of a carbon nanotube, a silver nanowire, a boron carbide nanowire, nanocellulose, a copper hydroxide nanowire, a silicon monoxide nanowire, and a hydroxyapatite nanowire.

7. The battery separator according to claim 1, wherein the base material is an organic polymer material; the organic polymer material comprises polyolefin; and the polyolefin comprises polyethylene.

8. The battery separator according to claim 1, wherein the first element is in a porous structure.

9. A method for manufacturing a battery separator, the battery separator comprising a first element and a second element, wherein the first element is loaded on the second element in a layered manner, and the first element is formed by nanowires;
the manufacturing method comprises steps of:
providing a dispersion solution in which the nanowires are dispersed in a dispersant; and
transferring the dispersion solution onto a surface of the second element, and removing the dispersant in the dispersion solution from the surface of the second element so that the nanowires are loaded on the surface of the second element in the layered manner.

10. The method for manufacturing a battery separator according to claim 9, wherein the dispersant comprises one or more of water, ethanol; acetone, and N-methylpyrrolidone.

11. The method for manufacturing a battery separator according to claim 10, wherein the dispersion solution further contains an adhesive; the adhesive comprises one or more of polyvinyl alcohol, polyacrylonitrile, polyacrylic acid, styrene butadiene rubber, carboxymethyl cellulose, polyvinylidene fluoride, polyvinylpyrrolidone, and polyimide; and the dispersion solution further comprises an auxiliary agent.

12. The method for manufacturing a battery separator according to claim 10, wherein mass concentration of the nanowires in the dispersion solution is 0.01 to 50% and mass concentration of the adhesive is 0.01 to 49%.

13. The method for manufacturing a battery separator according to claim 9; wherein the dispersion solution is transferred to the surface of the second element by means of coating, and the coating comprises spin coating, or blade coating, or dip coating.

14. The method for manufacturing a battery separator according to claim 9, wherein the dispersed solution is transferred to the surface of the second element by dip coating; and the dip coating method comprises:
dipping the second element into the dispersion solution at a first given speed and withdrawing the second element from the dispersion solution at a second given speed under a condition where the second element is tensioned by being stretched,
the second element is tensioned by a tensioning system consisting of a plurality of rollers, wherein the tensioning system has at least one dip coating roller configured to dip the second element into the dispersion solution, and the dip coating roller is partially or entirely immersed in the dispersion solution;
the dip coating roller has a hollow cavity; and the dip coating roller has pore channels communicating with the hollow cavity and extending to its surface; the second element is in contact with the surface of the dip coating roller in such a manner that the surface of the dip coating roller and the surface of the second element are attached to each other, and the hollow cavity is held at a given vacuum degree, and the vacuum degree is 0.01 to 0.1 MPa.

15. A battery, having the battery separator according to claim 1.

16. The battery according to claim 15, wherein the battery is a lithium ion battery.

17. The battery according to claim 16, wherein the lithium ion battery is a rechargeable lithium ion battery.

18. The battery according to claim 15, wherein the battery comprises a housing in which the battery separator and positive and negative electrodes separated by the battery separator are disposed; a positive electrode region is formed between the positive electrode and the battery separator, and a negative electrode region is formed between the negative electrode and the battery separator.

19. The battery according to claim 18, wherein same electrolyte is injected into the positive electrode region and the negative electrode region.
